(19) United States
(12) Patent Application Publication
(10) Pub. No.: US 2025/0269351 A1
(43) Pub. Date: Aug. 28, 2025

(54) NITROGEN DOPED GRAPHENE ACID, METHOD OF PREPARATION AND USE THEREOF

(71) Applicant: UNIVERZITA PALACKEHO V OLOMOUCI, Olomouc (CZ)

(72) Inventors: Michal OTYEPKA, Olomouc (CZ); David PANACEK, Olomouc (CZ); Aristeidis BAKANDRITSOS, Olomouc (CZ); Radek ZBORIL, Olomouc (CZ)

(21) Appl. No.: 18/858,243

(22) PCT Filed: Apr. 21, 2022
(86) PCT No.: PCT/CZ2022/050042

§ 371 Date: Oct. 18, 2024

(51) Int. Cl. B01J 20/22; B01J 20/28; B01J 20/30; C01B 32/194; C02F 1/28; C02F 101/20; C02F 103/00

(52) U.S. Cl. CPC B01J 20/22; B01J 20/28007; B01J 20/28016; B01J 20/3071; B01J 20/3078; B01J 20/3085; C01B 32/194; C02F 1/288; C01P 2002/82; C01P 2002/85; C01P 2004/04; C01P 2006/60; C02F 1/283; C02F 1/285; C02F 2101/20; C02F 2103/007

(57) ABSTRACT

The present invention provides nitrogen doped graphene acid containing 3 to 10 at. % (preferably 4 to 6 at. %) of nitrogen and 25 to 45 at. % (preferably 30 to 38 at. %) of oxygen, relative to the total atoms present in the sample and determined by X-ray photoelectron spectroscopy (XPS) using an Al—Kα source. In some embodiments, the nitrogen doped graphene acid is in the form of dots. The nitrogen doped graphene acid is produced by a method which contains the following steps: —providing nitrogen doped graphene, —oxidizing the nitrogen doped graphene by reaction with an oxidizing inorganic acid, preferably with nitric acid, —washing the resulting mixture with water. The nitrogen doped graphene acid is particularly useful for sequestration of Pb²⁺ and/or Cd²⁺ from water or for detection of Pb²⁺ and/or Cd²⁺.

### FIELD OF ART

The present invention relates to a nitrogen doped graphene acid, nitrogen doped graphene acid dots, methods of preparation thereof, and use thereof in heavy metal sequestration and heavy metal sensing.

### BACKGROUND ART

Access to clean water, one of the major sustainable development goals of the United Nations, is essential for drinking, sanitation, and food security. Thus, technologies for cleaning water and quality-monitoring must become widely accessible and of low-cost, without sacrificing effectiveness, selectivity, sustainability, and eco-friendly features. In order to meet this challenge, we developed heterobifunctional nanographene fluorescent beacons with high-affinity pockets for heavy metals, offering top-rated and selective adsorption for cadmium and lead, reaching 870 mg·g⁻¹ and 450 mg·g⁻¹, respectively. The heterobifunctional and multidentate pockets also operated as selective gates for fluorescence signal regulation with sub-nanomolar sensitivity (0.1 nM and 0.2 nM for Pb²⁺ and Cd²⁺, respectively; 0.02 ppb for both), due to binding affinities as low as those of antigen-antibody interactions. Importantly, the acid-proof nanographenes can be fully regenerated and reused. Their broad visible-light absorption offers an additional mode for water-quality monitoring based on ultra-low cost and user-friendly reagentless paper detection with naked-eye at a limit of detection of 1 ppb and 10 ppb for Pb²⁺ and Cd²⁺ ions, respectively. This work shows that photoactive nanomaterials, densely-functionalized with strong and yet selective ligands for targeted contaminants, can successfully combine features such as excellent adsorption, reusability and sensing capabilities, in a way to extend the material's applicability, its life-cycle, and value-for-money.

The increasing impact on the worldwide eco-systems of anthropogenic activities leads to the accumulation of toxic heavy metals in the earth's upper crust, turning the availability of quality water for drinking and sanitation (a major sustainable development goal of the United Nations) a growing challenge. This has propelled intensive research efforts for the development of sophisticated sorbents integrating features of high added-value, such as recyclability, catalytic activity after metal sorption, or utilization of the same material for water-quality monitoring. The combination of water decontamination and user-friendly water-quality monitoring is particularly attractive, since the two applications are highly complementary, both from mechanistic and practical aspects. A potent sorbent requires a material which can attract the target analyte onto its surface with high affinity, significantly increasing locally the analyte's concentration. This may greatly impact the sensing if the sorbent simultaneously offers an analyte dependent signal. However, high selectivity for the toxic metals is often an issue (Gogoi et al. ACS Appl. Mater. Interfaces 2015, 7, 3058; Wang et al. Sens. Actuators B Chem. 2015, 207, 25; Shi et al. ACS Appl. Mater. Interfaces 2014, 6, 2568), while the combined sorption and sensing of target analytes is particularly challenging (Pournara et al. J. Mater. Chem. A 2019, 7, 15432; Ding et al. J. Am. Chem. Soc. 2016, 138, 3031; Zhang et al. ACS Cent. Sci. 2018, 4, 1697).

### SUMMARY OF THE INVENTION

The present invention provides nitrogen doped graphene acid (NGA) containing 3 to 10 at. % (preferably 4 to 6 at. %) of nitrogen and 25 to 45 at. % (preferably 30 to 38 at. %) of oxygen, relative to the total atoms present in the sample and determined by X-ray photoelectron spectroscopy (XPS) using an Al—Kα source.

There is typically at least a minimum residual content of fluorine which is about 0.1 at. % up to about 1.3 at. %, relative to the total atoms present in the sample and determined by X-ray photoelectron spectroscopy (XPS) using an Al—Kα source.

The nitrogen doped graphene acid exhibits an infra-red band between 1690 cm⁻¹ and 1750 cm⁻¹, and an infra-red band between 1180 cm⁻¹ and 1250 cm⁻¹, which bands are among the 5 stronger bands in the infra-red spectrum, as determined by attenuated total reflectance (ATR) FT-IR spectroscopy. The nitrogen doped graphene acid additionally exhibits photoluminescence with a peak between 475 nm and 600 nm when excited at 470 nm, as determined with a fluorescence spectrometer at room temperature with a sample dispersed in deionized water.

The nitrogen doped graphene acid contains nitrogen atoms, carboxylic groups, carbonyl (C═O) groups and C—O groups. Out of the total carbons, about 10-30 at. % correspond to carboxylic carbons, about 5-20 at. % correspond to carbonyl carbons, and about 5-20 at. % correspond to C—O carbons, as determined by X-ray photoelectron spectroscopy (XPS) using an Al—Kα source.

The nitrogen doped graphene acid is preferably in the form of particles having the largest dimension of up to 500 nm, more preferably up to 200 nm, even more preferably up to 100 nm. The particles are typically single-layered or few-layered sheets.

In some embodiments, the present invention provides nitrogen doped graphene acid in the form of nitrogen doped graphene acid dots (NGA-D). The nitrogen doped graphene acid dots are small particles having the size of 1-5 nm, preferably 2-3 nm (e.g., size of flock 1-5 nm, average thickness of 3 nm).

The particle sizes (incl. largest dimension of NGA) are as determined by transmission electron microscopy (TEM), the thicknesses are as determined by atomic force microscopy (AFM).

The present invention further provides a method for preparation of nitrogen doped graphene acid, which contains the following steps:
providing nitrogen doped graphene,
oxidizing the nitrogen doped graphene by reaction with an oxidizing inorganic acid, preferably with nitric acid,
washing the resulting mixture with water.

The preparation of nitrogen doped graphene acid dots further involves the step of heating the nitrogen doped graphene acid at 80-100° C. for at least 24 hours, preferably for at least 48 hours, even more preferably for at least 70 hours (hydrothermal treatment).

Nitrogen doped graphene is known, e.g., from WO 2021/223783, where it is produced as a supercapacitor material.

Nitrogen-doped graphene may be prepared by the following steps (according to WO 2021/223783):
a) providing a dispersion of fluorinated graphite;
b) subjecting the dispersion of fluorinated graphite to sonication and/or mechanical treatment and/or thermal treatment;
c) contacting the product from step b) with an azide reagent at a temperature of 40 to 200° C.;
d) separating the solid product (nitrogen-doped graphene) formed in step c) from the mixture;
e) optionally dialysis of the product against water.

The term “fluorinated graphite” includes fluorographite, graphite fluoride, fluorinated graphite, and exfoliated forms of these materials. Fluorinated graphites are also available under the name poly(carbon monofluoride), carbon monofluoride or poly(carbon fluoride). The initial content of fluorine in the starting fluorinated graphite is typically at least 40 at. %, more preferably at least 45 or at least 50 at. %, relative to the total atoms present in the sample and determined by X-ray photoelectron spectroscopy (XPS) using an Al—Kα source.

The term “nitrogen doped graphene” means graphene with N-atoms (nitrogen atoms) incorporated in the graphene lattice. This term encompasses single-layer graphene, as well as materials comprising single-layer graphene in a mixture with moieties (e.g., flakes) or particles containing a plurality of graphene layers. However, this term also covers graphene wherein a small proportion (e.g., up to 10% or up to 5%) of the nitrogen atoms are bound to the carbon atoms as out-of-plane substituents (e.g. amino-groups), i.e. not incorporated in the graphene lattice. This term also covers graphene wherein a small amount of fluorine is present as well (up to 16.6 at. %; preferably lower than 5 at. %).

Mechanical treatment preferably includes at least one treatment selected from high-shear mixing, stirring, vigorous stirring, stirring with magnetic bar, stirring with a mechanical stirrer.

Thermal treatment preferably includes heating the dispersion in step b) to a temperature within the range of 50 to 250° C., or from 80 to 200° C., or more preferably from 100 to 150° C. It can also include the treatment inside a solvothermal reactor at pressures higher than the normal atmospheric pressure.

The dispersion prepared in step a) is a dispersion of fluorinated graphite in a solvent. The solvent is preferably a polar solvent or a mixture of a polar and a non-polar solvent. The solvent may preferably be selected from dimethylformamide (DMF), dimethylsulfoxide (DMSO), N-methyl-2-pyrrolidone (NMP), N,N-dimethylacetamide (DMA), glycols such as ethylene glycol, and mixtures thereof. Less polar or non-polar solvents such as acetonitrile, benzene, toluene or chlorobenzene may be used in combination with a polar organic solvent (for example DMF, NMP, DMSO, DMA).

The step of sonication and/or mechanical treatment and/or thermal treatment yields a mixture containing fluorinated graphene and/or exfoliated fluorinated graphite particles. Sonication is typically carried out at frequency range of 20 kHz to 100 kHz and for a period of at least 2 hours, more preferably of at least 3 hours, even more preferably at least 4 hours. The thermal treatment is typically carried out at the temperature range of 40-200° C. and for a period of at least 1 hour or preferably at least 6 hours, more preferably at least 24 hours, even more preferably 80 hours. The mechanical treatment is most typically carried out by high-shear mixing or magnetic bar stirring.

The azide reagent is preferably added to the solvent of the reaction as a powder or in the form of a suspension in a solvent.

The solvent is preferably a polar solvent. The solvent may preferably be selected from dimethylformamide (DMF), dimethylsulfoxide (DMSO), N-methyl-2-pyrrolidone (NMP), N,N-dimethylacetamide (DMA), glycols such as ethylene glycol, and mixtures thereof. Less polar or non-polar solvents such as acetonitrile, benzene, toluene or chlorobenzene may be used in combination with a polar organic solvent (for example DMF, NMP, DMSO, DMA). In a particularly preferred embodiment, the solvent is the same as the solvent used for preparing the dispersion of fluorinated graphene prepared in step b).

The azide reagent may preferably be selected from metal azides, tri(C1-C4)alkylsilyl azides. More preferably, the azide reagent is selected from NaN₃, KN₃, LiN₃, Pb(N₃)₂, trimethylsilyl azide.

After contacting the product of step b) containing fluorinated graphene with the azide reagent, the mixture is typically subjected to heating to a temperature within the range of 40-200° C., preferably 70-170° C., even more preferably 100-140° C. The heating is preferably carried out for at least 4 hours, preferably for 4 hours to 20 days, even more preferably for at least 8 hours, yet more preferably for at least 24 hours, and even more preferably for at least 2 days (48 hours) or for at least 3 days (72 hours). The longer is the period of heating, the higher is the nitrogen doping.

The step of isolation of the product (nitrogen-doped graphene) may be performed by known techniques such as centrifugation, sedimentation or filtration.

Specifically, for the experiments and assays carried out by the inventors, nitrogen doped graphene was produced as follows: 0.5 g of fluorographite was dispersed in a teflon vial in 30 ml of DMF and sonicated for 24 hours. Then 3 g of NaN₃ was added to the previous mixture transferred to spherical flask and left stirring and heating on 130° C. for 3 days with a condenser in the hood. After the end of the reaction, the sample was washed in falcons with DMF (3×), acetone (3×), ethanol (3×), distilled water (3×) and hot distilled water (2×), using centrifugation (14000 rcf).

The step of oxidizing the nitrogen doped graphene by reaction with an oxidizing inorganic acid may preferably be carried out with concentrated nitric acid (i.e., 65-98% (v/v) aqueous nitric acid), more preferably with 65-70% (v/v) aqueous nitric acid. The reaction is preferably carried out at a temperature within the range of 40-200° C., preferably 70-170° C., even more preferably 100-140° C. The heating is preferably carried out for at least 4 hours, preferably for 4 hours to 20 days, even more preferably for at least 8 hours, yet more preferably for at least 24 hours, and even more preferably for at least 2 days (48 hours).

The nitric acid is preferably added to nitrogen-doped graphene which is in the form of a liquid dispersion.

The resulting nitrogen doped graphene acid may be isolated by any of known techniques such as centrifugation, sedimentation or filtration.

The washing step is carried out in order to purify the product. The washing may be performed with hot distilled water (at least 70° C.) and distilled water. The purity may be further increased by performing dialysis of the product against water.

In order to convert the nitrogen doped graphene acid into dots, the nitrogen doped graphene acid obtained from the oxidation step and washing step is put in autoclave and typically subjected to heating to a temperature within the range of 40-150° C., preferably 70-120° C., even more preferably 90-100° C. The heating is preferably carried out for at least 4 hours, preferably for 4 hours to 5 days, even more preferably for at least 8 hours, yet more preferably for at least 24 hours, and even more preferably for at least 2 days (48 hours). This step is also called herein “hydrothermal treatment”.

The step of isolation of the product (nitrogen-doped graphene acid dots) may preferably be performed by dialysis against water or by filtration through an at least 5 nm ultracentrifuge filter.

In a preferred embodiment, the nitrogen doped graphene acid after the washing step and/or the nitrogen doped graphene acid dots after the hydrothermal treatment are subjected to a step of dialysis against water.

The present invention further relates to the use of the nitrogen doped graphene acid or nitrogen doped graphene acid dots for sequestration of Pb²⁺ and/or Cd²⁺ from water. The source water can be, e.g., river water, drinking water, wastewater. Within the framework of the invention, it was found that the selectivity and affinity of nitrogen doped graphene acid or nitrogen doped graphene acid dots is exceptional, and higher than any other adsorbent with the exception of AuNP. However, the nitrogen doped graphene acid or nitrogen doped graphene acid dots are superior over AuNP because they can be recycled and reused. The recycling is performed by desorption of the metals from the surface with a strong acid solution, for example hydrochloric acid, preferably 1-5% v/v aqueous HCl solution.

The invention further involves a method of sequestration (i.e., adsorptive removal, remediation) of Pb²⁺ and/or Cd²⁺ from water, comprising the step of contacting water to be purified of Pb²⁺ and/or Cd²⁺ with the nitrogen doped graphene acid of the present invention. In some embodiments, the method further comprises a step of recycling the nitrogen doped graphene acid after the contacting step by washing it with an inorganic acid, preferably hydrochloric or hydrobromic acid, and contacting it with a new batch of water to be purified of Pb²⁺ and/or Cd²⁺.

In another aspect, the invention relates to the use of the nitrogen doped graphene acid or nitrogen doped graphene acid dots for detecting Pb²⁺ and/or Cd²⁺. The detection may be carried out by lateral flow paper sensors, or by measuring photoluminescence of nitrogen doped graphene acid dots. The photoluminescence is performed under excitation at 400-500 nm, preferably at 467±2 nm, and recording emission at 520-530 nm. The absorption/binding of Pb²⁺ and/or Cd²⁺ quenches this luminescence.

The prepared nitrogen doped graphene acid offers top-rated and selective adsorption for cadmium and lead, reaching 870 mg g⁻¹ and 450 mg g⁻¹, respectively. Moreover, nitrogen-doped graphene acid retains its adsorption capacities for both Pb²⁺ and Cd²⁺ for at least six regeneration cycles at levels higher than 90%. The same material also operates as selective gates for fluorescence signal regulation with sub-nanomolar sensitivity (0.1 nM and 0.2 nM for Pb²⁺ and Cd²⁺, respectively; 0.02 ppb for both.

The process allowing to achieve these properties is simple and effective and uses economically effective starting compounds. In particular, the method of the invention is the only wet-process chemical method which can achieve such nitrogen doping and particularly high oxidation. Additionally, it is the only method achieving a high nitrogen doping and high oxygen contain at relatively low reaction temperature.

Nitrogen doped graphene acid has a balanced mixture of parameters that allows it to be used as a heavy metal sorbent and as a detection probe without the drawbacks typical of materials known in the art. In particular, its unprecedented ability to detect lead and cadmium through photoluminescence quenching, combined with its ability to absorb ions from solution, results in a material exhibiting these properties superior to any previous N and O containing graphene-based material to date. The highest value obtained for the material showing both adsorption capacity and heavy metal detection, as described in the literature, was for adsorption capacity (˜522 mg g⁻¹; and 220 mg g⁻¹ for Pb²⁺ and Cd²⁺, respectively) and detection limits of 3.0 nM and 11.6 nM for Pb²⁺ and Cd²⁺, respectively.

### BRIEF DESCRIPTION OF DRAWINGS

FIG. 1. X-ray photoelectron spectra of a) the starting nitrogen doped graphene (NG); b) nitrogen doped graphene acid (NGA); c) nitrogen doped graphene acid after hydrothermal treatment (dots, NGA-D).

FIG. 2. Infra-red spectra of a) the starting nitrogen doped graphene b) nitrogen doped graphene acid c) nitrogen doped graphene acid after hydrothermal treatment.

FIG. 3. a) Comparison of PL spectra of NG, NGA and NGA-D (λex=470 nm, 0.5 mg mL⁻¹). b) UV-Vis absorption spectra of NG, NGA and NGA-D, along with the excitation (λex=467 nm) and PL (λem=527 nm) spectra of NGA-D. c) Time-resolved PL decay (λem=527 nm) with corresponding stretched-exponential fit for derivation of the PL lifetime.

FIG. 4. Transmission electron microscopy (TEM) images of a) the nitrogen doped graphene, b) nitrogen doped graphene acid and c) nitrogen doped graphene acid dots. d) histogram of particle size distribution.

### EXAMPLES OF CARRYING OUT THE INVENTION

### Materials and Methods

### Adsorption Experiments.

The batch method was applied, at 4 mL of volume, using 1 to 75 mg L⁻¹ of sorbent; thus, the volume to sorbent mass ratio of the experiments was V:m≈13 L g⁻¹, and initial [Meⁿ⁺] feed from 1 to 100 ppm. The pH of the solutions was adjusted by 1% v/v HCl and 1% w/v NaOH solutions. The samples were shaken on a rotating shaker for 60 min and then filtered through a 200 nm syringe filter (Whatman, mixed cellulose ester). The residual metal concentration was determined using the AAS method. The whole experiment was performed three times. For the metal ion selectivity experiments, mineral drinking water and river water were used, with the following composition for mineral water; (mg L⁻¹): Mg²⁺ 6.98; Ca²⁺ 26.3; Na⁺ 0.967; K⁺ 2.08; Fe<0.002; NH₄⁺<0.05; HCO₃⁻ 102; NO₃⁻ 6.3; SO₄²⁻ 13.2; NO₂⁻<0.005; F⁻<0.2; Cl⁻ 3.05 and for river water; Mg²⁺ 6.5; Ca²⁺ 37.3; Na⁺ 9.7; K⁺ 3.2 Maximum adsorption capacities qₘmax (mg g⁻¹) were calculated by the equation

$${q}_{ma x} = \frac{V ( {C}_{0} - {C}_{e} )}{m}$$

where V is the sample volume (L), C₀ is the initial concentration of the metal (mg L⁻¹), Cₑ is the equilibrium concentration (mg L⁻¹) and m is the mass (g) of sorbent used.

Another adsorption experiment was carried out to obtain information on the behavior of ions in solution at different pH without using graphene material (NGA). A solution of a given metal salt (Pb²⁺ or Cd²⁺) at a precise concentration (at metal feed of 100 ppm) was purposely adjusted (2% NaOH and 2% HCl) to achieve different pH values ranging from 3 to 8. The effect of pH on the sorption capacity of the metal salt solutions thus prepared was subsequently studied. The given solution with different pH values was filtered using a syringe filter with a pore size of 200 nm and then the filtrate was submitted to AAS measurements to obtain information on what concentration of metal was captured by the filter, respectively what concentration passed through the filter.

### The Kinetics of Sorption.

The batch method was applied, at 4 mL of volume, using 1 to 75 mg L⁻¹ of sorbent; thus, the volume to sorbent mass ratio of the experiments was V:m≈13 L g⁻¹, and initial [Meⁿ⁺] feed from 1 to 100 ppm. The pH of the solutions was adjusted by 1% v/v HCl and 1% w/v NaOH solutions. Samples were shaken on a rotary shaker for different times: 0.5 min, 1 min, 5 min, 10 min, 15 min, 30 min and 60 min, then filtered through a 200 nm syringe filter (Whatman, mixed cellulose ester). The residual metal concentration was determined using the AAS method.

### Metal Desorption.

In sorbent regeneration and reusability experiments the weight ratio NGA:Me (NGA to metal) was kept at 10:1. The process included three steps: (i) washing the sorbent with water with 4 mL (three times) to study the leaching of the metals from the NGA surface, (ii) desorption of the metals from the surface of NGA with a 2% v/v HCl solution of volume 4 mL (three times), and (iii) washing with distilled water or with 1% w/v NaOH and neutralization of NGA by 4 mL of water (three times), for reusability tests. All samples for characterization were prepared under the same conditions with weight ratios of 75 mg L⁻¹ of NGA and 1 mg L⁻¹ of Meⁿ⁺.

### Paper-Based Detection.

Sensor preparation: chromatographic paper (Whatman) was used as a substrate for the lateral flow of NGA material (NGA filtered with a 200 nm cellulose filter). The paper was cut to a size of 8.5 cm×2 cm and in the next step to barriers for the NGA flow were applied using a wax printer (Xerox, ColorQube 8580). The channel width for the proper flow of NGA was set to 2 mm after experiments. After applying the wax ink, the sensor was placed in an oven preheated to 90° C. for 2 minutes in order to incorporate the wax into paper.

Detection preparation: The process included four steps: (I) the paper sensor was immersed in a solution with metals (Pb²⁺ or Cd²⁺), then dried in air, this process was repeated three times to increase the detection limit, (II) a total volume of 1.5 μL of NGA (13.5 μg) was put onto the paper sensor by drop-casting 3 times at a volume of 0.5 μL, (III) a total volume of 1.5 μL of sample of the metal solution was applied onto the spot of NGA by drop-casting 3 times a volume of 0.5 μL and left for 1 hour. (IV) the prepared sensor was placed in a container of metal solution (0.5 mL) for 30 min, then dried in air and then the NGA path distance was measured. In order to increase the detection limit, 50 mL of the metal solution was evaporated on a water bath at 60° C. for 2 hours to a final volume of 0.5 mL and then the same procedures (I-IV) were applied.

### PL Detection:

For this detection purpose, NGA-D material with a concentration of 0.5 mg mL⁻¹ was used. 1.8 mL of NGA-D was placed in a quartz cuvette and then 0.2 mL of metal solution of predetermined concentration by AAS was added. The solution thus prepared was allowed to react for 5 min and then PL was measured to determine the contamination of the solution by PL quenching.

The limits of detection (LoD) were calculated by the equation:

$$LoD = 3 \times ( SD / S )$$

where SD is the standard deviation of the blank (NGA-D), and S is the slope of the linear fit from the F0-F values and the standard deviation of the individual measured metal concentrations.

For the metal ion selectivity experiments mineral drinking water and the spiked tap water were used, with the following composition for bottled mineral water; (mg L⁻¹): Mg²⁺ 6.98; Ca²⁺ 26.3; Na⁺ 0.967; K⁺ 2.08; Fe<0.002; NH₄⁺<0.05; HCO₃⁻ 102; NO₃⁻ 6.3; SO₄²⁻ 13.2; NO₂⁻<0.005; F⁻<0.2; Cl⁻ 3.05 and for the regional tap water; Mg²⁺ 10.3; Ca²⁺ 91.7; Na⁺ 0.767; K⁺ 1.9; Fe<0.1; NH₄⁺<0.05; HCO₃⁻ 102; NO₃⁻ 16.3; NO₂⁻<0.007; F⁻<0.19; Cl⁻ 0.09

### Computational Details.

The strength of the interaction of the divalent cations with NGA-D was also evaluated with theoretical calculations. For this, the binding energies of Pb²⁺, Cd²⁺ and Ca²⁺ with a smaller model of NGA-D (three binding positions) and Pb²⁺, Cd²⁺ with a bigger model of NGA-D (four binding positions) were calculated. The binding energies correspond to the energy difference between the complex and fragments (NGA-D and ion), where fragments have the geometry of the complex. All models were modeled as protonated, which represent the conditions at lower pH, one binding position was also modeled for the smaller NGA-D model with all deprotonated carboxylic groups representing behavior in basic environment. The density functional theory (DFT) was used for all calculations, including geometry optimizations, frequency analysis and evaluation of the binding energies. The calculations were performed in Gaussian16 (revision B.01)^{[1]} and B3LYP^{[2]} functional with D3 correction for dispersion^{[3]} were employed. Main group elements (C, O, N, H) were described with def2-SVP^{[4,5]} basis set, while the cations with LANL2DZ^{[6]} effective core potential. All calculations were performed in water medium, employing an implicit solvation model based on density (SMD)^{[7]} water model. The natural bond orbital (NBO) analysis^{[8]} was also carried out in Gaussian16 (Gaussian NBO version 3.1) by examining all possible interactions between donor Lewis-type NBOs and acceptor non-Lewis NBOs, evaluation of E⁽²⁾ energies by second-order perturbation theory^{[9]}, and calculation of Wiberg bond indices.^{[10]} All structures were relaxed to their geometrical minima, as was verified by frequency analysis.

### Adsorption Isotherms.

For the determination of adsorption isotherms describing adsorption of Pb²⁺ and Cd²⁺ ions onto NGA material, sorption experiments were performed by dispersing 300 μg of the NGA material in 4 mL of the solution containing relevant heavy metal nitrate with weight concentration of the metal ranging from 5 to 150 ppm. The samples were shaken on a rotating shaker for 60 min at room temperature (25° C.) and then filtered through a 200 nm syringe filter (Whatman, mixed cellulose ester). The residual metal concentration was determined using the AAS method. Adsorption capacities in equilibrium for each system were then calculated by the equation

$${Q}_{e q} = \frac{V ( {C}_{0} - {C}_{e q} )}{m}$$

where V is the sample volume (L), C₀ is the initial concentration of the metal (mg L⁻¹), C_{eq} is the equilibrium concentration of the non-adsorbed metal (mg L⁻¹) and m is the mass (g) of sorbent used.

### Instrumentation.

The materials (NG, NGA and NGA-D) were characterized by transmission electron microscopy (TEM) using a JEM 2010 TEM instrument (Jeol, Japan).

UV-Vis absorption spectra of all materials were measured in dilute colloidal suspension (0.5 mg mL⁻¹) using a Specord S600 spectrometer. (Analytik Jena, Germany).

Steady-state and time-resolved PL measurements were conducted using FLS980 fluorescence spectrometer (Edinburgh Instruments) equipped with a 450 W xenon arc lamp and EPL-375 ps pulsed diode laser (λₑₘ=372 nm with pulse width of 66.5 ps, a repetition rate of 10 MHz and an average power of 75 (μW) as the excitation sources. PL decay curve was fitted using a stretched exponential function: I(t)=I₀e^{-(t/τ)}^{^{β}}, where the fit parameters τ and β are the PL decay time and stretch parameter, respectively.

The band gap of the NGA-D was calculated using the Tauc equation. A Lambda 1050 UV/Vis/NIR spectrophotometer (PerkinElmer) was used.

The kinetic of PL quenching were evaluated with the Stern-Volmer plots of F0/F versus metal concentration using the function based on a bimolecular theory:

$$F / F 0 = 1 + {K}_{sv} [ Q ] = 1 + {K}_{q} \times τ [ Q ]$$

where Kₛᵥ and Q represent the Stern-Volmer quenching constant and metal concentration, respectively. K_{q} is the bimolecular quenching rate constant and τ is the average lifetime of the NGA-D without any quencher. F and F0 are the fluorescence intensities of NGA-D under the excitation of 467 nm with and without metal, respectively.

The concentration of heavy metals dispersion was measured using atomic absorption spectroscopy (AAS), on a ContrAA 600 with graphite furnace (Analytik Jena AG, Germany) equipped with a high-resolution Echelle double monochromator (spectral band width, 2 pm at 200 nm) and a xenon lamp as a continuum radiation source. For AAS measurements, heavy metals dispersion was added into a solution of nitric acid (2% w/w) and sonicated for 10 minutes in order to quantitatively dissolve all ions. The spiked tap water and river water were analyzed in a 7500 ce inductively coupled plasma mass spectrometry (ICP-MS) instrument (Agilent).

FTIR spectra were recorded on an iS5 FTIR spectrometer (Thermo Nicolet) using the Smart Orbit ZnSe ATR accessory. Briefly, a droplet of an ethanol dispersion of the relevant material was placed on the ZnSe crystal and dried. The spectra were then acquired by summing 52 scans while using a nitrogen gas flow through the ATR accessory. ATR and baseline correction were applied to the collected spectra. Raman spectra were recorded on a DXR Raman microscope using the 633 nm excitation line of a diode laser. For measuring 1.5 mg of materials were diluted in 3 mL of distilled water.

High-resolution X-ray photoelectron spectroscopy (HR-XPS) was carried out with a PHI VersaProbe II (Physical Electronics, Japan) spectrometer using an Al K_{α} source (15 kV, 50 W). The obtained data were evaluated and deconvoluted with the MultiPak (Ulvac—PHI, Inc.) software package. The spectral analysis process involved Shirley background subtraction and peak deconvolution using mixed Gaussian-Lorentzian functions. All binding energies are referenced with respect to C—C bond at 284.8 eV.

HR-TEM images were obtained using a HR-TEM TITAN 60-300 microscope with an X-FEG type emission gun, operating at 300 kV. Scanning transmission electron microscopy high-angle annular dark-field imaging (STEM-HAADF) analysis for EDS (energy-dispersive X-ray spectroscopy) elemental mapping on the products was performed with a FEI Titan HR-TEM microscope operating at 80 kV. For this analysis, a droplet of an aqueous dispersion of the material under study with a concentration of ˜0.1 mg mL⁻¹ was deposited on a carbon-coated copper grid and dried at room temperature for 24 hours. EPR spectra were collected on a JEOL JES-X-320 spectrometer operating at the X-band frequency equipped with an X-band Gunn oscillator bridge, a cylindric mode cavity and equipped with variable temperature control ES 13060DVT5 apparatus N₂ cryostat. The cavity Q quality factor was kept above 6000 in all experiments. Highly pure quartz tubes were employed (Suprasil, Wilmad, ≤0.5 OD) and accuracy on g-values was obtained against a Mn^{II}/MgO standard (JEOL standard). The EPR spectra were measured with the following parameters: microwave frequency=9.088 GHz, microwave power=1.0 mW, modulation width=0.35 mT, modulation frequency=100 Hz and temperature T of 80 K. All spectra were recorded with 30 ms time constant and 2 minutes sweep time, using 5 accumulations to improve signal to noise ratio. For all experiments the EPR tubes were loaded with 100 μl of solution containing the NGA-D or NGA (0.5 mg mL⁻¹) and with Pb²⁺, Cd²⁺ or Ca²⁺ solution (1 μM). The CW-LEPR experiments employed a HeCd laser (200 mW) source operating at 325 nm coupled to the EPR cavity resonator by optical fiber.

### Synthesis of Nitrogen Doped Graphene Acid and of Nitrogen Doped Graphene Acid Dots

### Preparation of Nitrogen Doped Graphene:

In a glass spherical flask, 1 g of graphite fluoride was dispersed in 40 ml of DMF. The flask was covered and left stirring for 2 days. Then, it was sonicated for 4 hours and left stirring overnight. In a glass beaker, 2 g of NaN₃ was dissolved in 20 ml of DMF and then added to the graphite fluoride and/or few-layer fluorographene dispersion. The mixture was heated at 130° C. for 72 h in the hood with a condenser under stirring with teflon coated magnetic bar. After the end of heating, the reaction mixture was left to cool down and transferred to 50 ml falcon centrifuge tubes. The solid particles (the product) were separated from the solvent and by-products by centrifugation at 15000 rcf for ca. 10 mins. The supernatant was discarded, and the tube was refilled with the next washing solvent. The sample was homogenized by shaking for at least 1 minute to redisperse the precipitate in the new solvent. Washing was performed with different solvents: DMF (3×), acetone (3×), ethanol (3×), hot ethanol (1×), distilled water (3×) and hot distilled water (1×), then refilled back with distilled water.

### Preparation of Nitrogen Doped Graphene Acid:

An amount of the previously prepared N-doped graphene derivative was treated with 65% v/v nitric acid for 24 h at 100° C. in a glass flask with condenser. After the end of the reaction the product was purified by washing in 15 ml falcons with hot distilled water (3×) and distilled water (5×). At the end, the dispersed solid was inserted in a dialysis bag (molecular weight cut-off 10 kDa) until the conductivity of the surrounding water stopped increasing above ca. 10 μS/cm and the conductivity inside the dialysis bag was ca. 5 μS/cm. The dispersion was finally removed from the dialysis bag and was stored for further use or dried.

### Preparation of Nitrogen Doped Graphene Acid Dots:

The nitrogen graphene acid was filtered through a 200 nm syringe filter (Whatman, mixed cellulose ester), then the filtrate was transferred in a teflon-coated autoclave and heated at 90° C. in an oven for 72 hours. After the end of the reaction the sample was filtered through a 5 nm ultracentrifuge filter (10 kDa cutoff membrane) and purified by dialysis (dialysis tubing benzoylated, 2 kDa cutoff), until the conductivity of the surrounding water stopped increasing above ca. 10 μS/cm and the conductivity inside the dialysis bag was ca. 5 μS/cm.

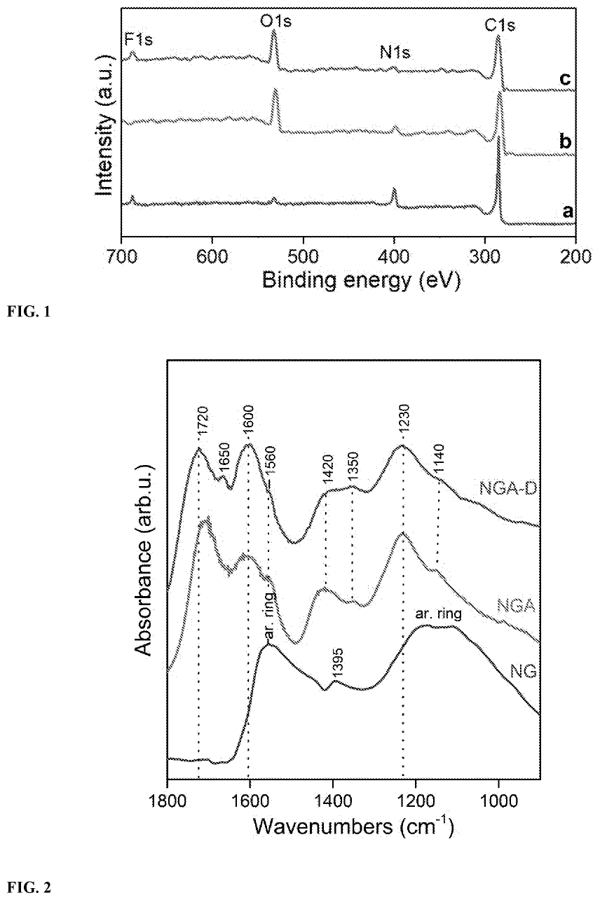

X-ray photoelectron spectroscopy on the nitrogen doped graphene (FIG. 1a) showed that the reaction with NaN₃ resulted in the introduction of N atoms in the product, reaching 11.6 at. % after 72 h of reaction, and in significant loss of fluorine atoms from 50.5 at. % to 2.2 at. % (Table 1).

X-ray photoelectron spectroscopy on the nitrogen doped graphene acid (FIG. 1b) showed that the reaction with HNO₃ resulted in the decrease of the proportion of N atoms in the product, reaching 5.2 at. % after 24 h of reaction, and in significant increasing of oxygen atoms from 3 at. % to 32.7 at. % (Table 2).

X-ray photoelectron spectroscopy on the nitrogen doped graphene acid dots (FIG. 1c) showed that the reaction in autoclave resulted in a further decrease of the proportion of N atoms in the product, reaching 4.9 at. % after 72 h of reaction and increasing of oxygen atoms from 32.7 at. % to 36.6 at. % (Table 3).

Fourier-transformed infra-red spectroscopy (FT-IR) showed that the nitrogen doped graphene (FIG. 2, NG) spectrum was dominated by two bands at 1560 cm-1 and between 1000-1210 cm⁻¹, both corresponding to skeletal vibrations of the sp2 aromatic carbon network and to aromatic rings. The feature at 1395 cm⁻¹ indicated heteroatom substitution in aromatic rings, e.g., to pyridinic ring vibrations. In agreement with XPS, the spectra of nitrogen doped graphene acid NGA and nitrogen doped graphene acid dots NGA-D revealed the characteristic stretching band of the carbonyl group at 1720 cm⁻¹ (FIG. 2, NGA, NGA-D) from the carboxyls. The broad band at 1230 cm⁻¹ changed its pattern in comparison to NG, comprising now also the C—O stretching modes from the carboxylic groups. Ionization of the carboxylic groups to carboxylates gave rise to additional vibrations at 1600 cm⁻¹ and at 1420/1350 cm⁻¹, ascribed to —CO2- asymmetric and symmetric stretching, respectively.

The band in NGA at 1140 cm⁻¹ reflects the presence of C—OH groups, which significantly decreased upon further oxidation in NGA-D, corroborating the XPS results. The aromatic ring vibrations at 1560 cm⁻¹ were present in both NGA and NGA-D, in agreement to the sp2 carbon components observed in XPS. The new band at 1650 cm⁻¹ in NGA-D was attributed to a small amount of organic nitrate groups (R—O—NO2)

TABLE 1
Atomic contents as obtained from X-ray photoelectron
spectroscopy analysis for nitrogen-doped graphene.

| Atomic contents % | C | N | O | F |
|---|---|---|---|---|
| nitrogen-doped graphene | 83.3 | 11.6 | 3.0 | 2.2 |

TABLE 2
Atomic contents as obtained from X-ray photoelectron spectroscopy
analysis for nitrogen-doped graphene acid.

| atomic contents % | C | N | O | F |
|---|---|---|---|---|
| nitrogen-doped | 61.4 | 5.2 | 32.7 | 0.6 |
| graphene acid | | | | |

TABLE 3
Atomic contents as obtained from X-ray photoelectron spectroscopy
analysis for nitrogen-doped graphene dots.

| atomic contents % | C | N | O | F |
|---|---|---|---|---|
| nitrogen-doped graphene | 57.3 | 4.9 | 36.6 | 1.2 |
| acid dots | | | | |

TABLE 4
Performance characteristics of the adsorption capacities from the
product nitrogen-doped graphene dots showing the maximal adsorption
capacities, pH of solution and the number of recycling

| | | Reuse | Cd²⁺ | Pb²⁺ |
|---|---|---|---|---|
| Material | pH | (cycles) | [mg · L⁻¹] | [mg · L⁻¹] |
| NGA | | | | |
| Meⁿ⁺ | 3.5 | 6 | 435 | 864 |
| feed = 100 ppm | | | | |
| Meⁿ⁺ | 5.5 | 6 | 450 | 880 |
| feed = 100 ppm | | | | |
| Me^{nt} | 6.5 | 6 | 570 | 1320 |
| feed = 100 ppm | | | | |

TABLE 5
Performance characteristics of the limit of detection
(LoD) from nitrogen-doped graphene dots.

| Metals | LoD [nm] |
|---|---|
| Pb²⁺ | 0.1 |
| Cd²⁺ | 0.2 |

### Characteristics of NGA and NGA-D:

Nitrogen doped graphene acid is effectively a carboxyl functionalized nitrogen doped graphene. It is synthesized by oxidation and size confinement by oxidizing acid, leading to a fluorescent and carboxyl-functionalized nitrogen-doped graphene acid (NGA). The NGA proved a very efficient and selective trap for Pb²⁺ and Cd²⁺ ions, facilitating exceptional water decontamination in presence of competing ions (Table 6), both in simulated and real samples. After a hydrothermal treatment of NGA and formation of 2-3 nm NGA dots (NGA-D), to further confine the lateral dimensions and boost the photoluminescence (PL) properties, the fast, reagentless and selective detection of Pb²⁺ and Cd²⁺ was achieved via PL quenching. The obtained LoDs (0.1 nM and 0.2 nM for Pb²⁺ and Cd²⁺, respectively) were unprecedented, surpassing the state-of-the-art schemes based on fluorometric and potentiometric methods, even many sensors using aptamers and DNA strands for sensitivity boosting (Table 7). The high sensitivity of the NGA-D was ascribed to the very strong binding for Pb²⁺ and Cd²⁺ inside a multivalent coordination pocket formed by the nitrogen doped-vacancies and the carboxyl groups, with association constants in the order of antigen antibody-interactions (10⁻⁶-10⁻⁹ L M⁻¹), and with a direct binding mechanism involving the formation of dark complexes with the ground-state of the NGA dots. Importantly, the acid-proof structure of NGA enabled its full regeneration and reuse as sorbent, while its broad visible-light absorption offered an additional sensing mode for the two toxic metals based on reagentless detection with naked-eye on paper, offering a solution for ultra-low cost, and user-friendly water quality monitoring.

TABLE 6
Comparative table of the limits of detection (LoD) of the NGA-D and
other materials based on optical and/or electrochemical sensing.

| Metals | Material | LoD | | Ref | Method | Selectivity |
|---|---|---|---|---|---|---|
| Pb²⁺ | NGA-D | 0.1 | nM | this | Optical | Pb²⁺, Cd²⁺ |
| Cd²⁺ | | 0.2 | nM | work | | |
| Pb²⁺ | ZnSe/QDs | 1.6 | nM | ^{[11]} | PL detection | Pb²⁺, Cd²⁺ |
| Cd²⁺ | | 2.2 | nM | | | |
| Pb²⁺ | GOQD | 4.4 | nM | ^{[12]} | PL detection | Pb²⁺, Cd²⁺, As³⁺ |
| Cd²⁺ | | 41.1 | nM | | | |
| Pb²⁺ | CDs | 37.1 | nM | ^{[13]} | Ratiometric PL | Pb²⁺, Co²⁺, Hg²⁺, Fe³⁺ |
| Pb²⁺ | GQDs/DDTC | 3.9 | μM | ^{[14]} | Resonance light | Pb²⁺ |
| | | | | | scattering | |
| Pb²⁺ | G/Fe₃O₄-AuNPs | 3 | nM | ^{[15]} | Fluorometric | N/A |
| Pb²⁺ | CDs | 0.14 | nM | ^{[16]} | PL detection | Pb²⁺, Hg²⁺ |
| Pb²⁺ | GO/AuNPs | 0.2 | nM | ^{[17]} | PL detection | Pb²⁺, Mn²⁺, Zn²⁺ |
| Pb²⁺ | CDs | 0.5 | nM | ^{[18]} | Optical/ABS | Pb²⁺, Cr⁶⁺, Cu²⁺, Fe³⁺, Mn²⁺ |
| Pb²⁺ | CDs | 0.6 | nM | ^{[19]} | PL detection | Pb²⁺ |
| Pb²⁺ | GO/QDs | 3.4 | nM | ^{[20]} | Ratiometric PL | Pb²⁺ |
| Pb²⁺ | CDs | 2 | nM | ^{[21]} | PL detection | Pb²⁺ |
| Pb²⁺ | CDs | 4.6 | nM | ^{[22]} | PL detection | Pb²⁺ |
| Pb²⁺ | Rhodamine- | 6.9 | nM | ^{[23]} | PL detection | Pb²⁺ |
| | Quinoline Conjugates | | | | | |
| Cd²⁺ | CQDs/AuNPs | 32.5 | nM | ^{[24]} | Ratiometric PL | Cd²⁺ |
| Cd²⁺ | QDs/Ag₂S | 546 | nM | ^{[25]} | NIR-II PL | Cd²⁺, Zn²⁺ |
| Cd²⁺ | N, Sdop/CDs | 18 | nM | ^{[26]} | PL detection | Cd²⁺ |
| Cd²⁺ | CdTe/CdS | 2.3 | nM | ^{[27]} | PL Electronic-eye | Cd²⁺ |
| Cd²⁺ | CdTe/CdS | 12 | nM | ^{[28]} | Ratiometric PL | Cd²⁺ |
| Cd²⁺ | CdTe/CdS | 10 | nM | ^{[29]} | PL detection | Pb²⁺ |
| Cd²⁺ | DPDB ligand | 8 | nM | ^{[30]} | Optical/ABS | N/A |
| Cd²⁺ | ZnSe/CdS | 11 | nM | ^{[31]} | Optical/ABS | Cd²⁺ |
| Pb²⁺ | μPEDs | 5 | nM | ^{[32]} | Electrochemical | N/A |
| Cd²⁺ | GQDs | 4.3 | nM | ^{[33]} | Electrochemical | Cd²⁺, Hg²⁺, Cu²⁺ |
| Cd²⁺ | Au/g-CNQDs | 10 | nM | ^{[34]} | Electrochemical | N/A |
| Pb²⁺ | Ca²⁺-MOF | 3 | nM | ^{[35]} | Electrochemical | Pb²⁺, Cd²⁺ |
| Cd²⁺ | | 11.6 | nM | | | |
| Pb²⁺ | GO/ZnO | 3.9 | nM | ^{[36]} | Electrochemical | N/A |
| Pb²⁺ | GO/[Ru(bpy)₃]²⁺ | 1.4 | nM | ^{[37]} | Electrochemical | Pb²⁺, Cd²⁺, Hg²⁺, As³⁺ |
| Cd²⁺ | | 2.8 | nM | | | |
| Cd²⁺ | GO-Fe₃O₄ | 0.6 | nM | ^{[38]} | Electrochemical | Pb²⁺, Cd²⁺ |
| Pb²⁺ | | 0.6 | nM | | | |
| Cd²⁺ | GO/PGA | 15 | nM | ^{[39]} | Electrochemical | Cd²⁺, Hg²⁺, Cu²⁺ |
| Cd²⁺ | GQDs | 13 | nM | ^{[40]} | Electrochemiluminescence | Cd²⁺ |
| Cd²⁺ | Au NPs | 0.001 | nM | ^{[41]} | tunnelling current | Cd²⁺, Hg²⁺ |

N/A = not avalible

[11] Junrui Zhouab et al., Sens. Actuators B Chem 2020.
[12] M. Park, T. S. Seo, Biosens. Bioelectron. 2019, 126, 405.
[13] F. Yarur et al., Environ. Sci. Nano 2019, 6, 1121.
[14] C. Kaewprom et al., Spectrochim. Acta. A. Mol. Biomol. Spectrosc. 2019, 207, 79.
[15] Z. Tao et al., Catalysts 2020, 10, 600.
[16] Z. Liu et al., Sens. Actuators B Chem. 2019, 296, 126698.
[17] X. Shi et al., ACS Appl. Mater. Interfaces 2014, 6, 2568.
[18] N. Gogoi et al., ACS Appl. Mater. Interfaces 2015, 7, 3058.
[19] A. Kumar et al., Sens. Actuators B Chem. 2017, 242, 679.
[20] D. Zhang et al., Inorg. Chem. 2017, 56, 14533.
[21] Q. Wang et al., Sens. Actuators B Chem. 2015, 207, 25.
[22] Y. Liu et al., Carbon 2017, 115, 550.
[23] M. Devi et al., RSC Adv. 2016, 6, 112728.
[24] W.-J. Niu et al., Carbon 2016, 96, 1034.
[25] Q. Wu et al., Anal. Chem. 2017, 89, 6616.
[26] M. Tang et al., Anal. Methods 2019, 11, 5214.
[27] X. Wang et al., Anal. Chim. Acta 2020, 1131, 126.
[28] R. Gui, X. An, W. Huang, Anal. Chim. Acta 2013, 767, 134.
[29] L. Chen et al., Sensors 2020, 20, 995.
[30] A. Shahat et al., Microchem. J. 2021, 164, 105967.
[31] Z.-Q. Zhou et al., Spectrochim. Acta. A. Mol. Biomol. Spectrosc. 2020, 228, 117795.
[32] Z. Nie et al., Lab. Chip 2010, 10, 477.
[33] L. Lu et al., ACS Nano 2018, 12, 12673.
[34] Z. Zhang et al., Appl. Energy 2018, 220, 87.
[35] A. D. Pournara et al., J. Mater. Chem. A 2019, 7, 15432.
[36] J. Yukird et al., Synth. Met. 2018, 245, 251.
[37] M. B. Gumpu et al., Talanta 2017, 162, 574.
[38] M. Baghayeri et al., Electrochimica Acta 2019, 312, 80.
[39] W. Yi, Z. He, J. Fei, X. He, RSC Adv. 2019, 9, 17325.
[40] L.-L. Li et al., Adv. Funct. Mater. 2012, 22, 2971.
[41] Eun Seon Cho et al., Nat. Mater 2012.

TABLE 7
Comparison of maximum sorption capacities (qₘ) of various
sorbents for Pb²⁺ and Cd²⁺ cations.

| | | Reuse | | | |
|---|---|---|---|---|---|
| Material | pH | (cycles) | Cd²⁺ | Pb²⁺ | ref |
| GO | acidic | — | 153^{I}/68^{II}/24^{III} | | ^{[42]} |
| GO | 6 | 2 | 106 | | ^{[43]} |
| rGO/FeOOH^{IV} | 3 | — | | 374 | ^{[44]} |
| MOF/rGO | 6 | — | 101 | 281 | ^{[45]} |
| GO20-CS1 | 6 | — | | 100 | ^{[46]} |
| PVA-GO-SA | N/A | 5↓* | 83 | 280 | ^{[47]} |
| Fe₃O₄-AA-CA | 5.5 | 4↓ | 30 | 166 | ^{[48]} |
| Fe₃O₄-GS | 3.5 | 5↓ | 28 | 28 | ^{[49]} |
| CNTs | 7 | — | 76 | 101 | ^{[50]} |
| NTA-silica gel | 5 | 5↓ | 53 | 76 | ^{[51]} |
| α-FeOOH | 5-7 | — | | 80 | ^{[52]} |
| MOF-EDTA | 5-6 | 4↓ | 528 | 313 | ^{[53]} |
| 2D Ca²⁺-MOF | ^{V} | — | 220 | 522 | ^{[35]} |
| FJI-H9 MOF | ^{VI} | 1 | 286 | | ^{[54]} |
| MoS₄²⁻-LDH | 6 | — | | 290 | ^{[55]} |
| rGO-Fe(0)-Fe₃O₄ | 7 | — | 4 | 20 | ^{[56]} |
| Graphene Acid | | 5 | | | |
| Meⁿ⁺ feed = 100 ppm | 3.5 | | 367 | 279 | ^{[57]} |
| Meⁿ⁺ feed = 100 ppm | 5.5 | | 527 | 490 | |
| Meⁿ⁺ feed = 100 ppm | 6.5 | | 710 | N/A | |
| Fe-MoF/PDA | 7 | 4 | | 394 | ^{[58]} |
| NG | | | | | |
| Meⁿ⁺ feed = 100 ppm | 3.5 | | 97 | 170 | |
| NGA | | | | | |
| Meⁿ⁺ feed = 100 ppm | 3.5 | 6 | 435 | 864 | |
| Meⁿ⁺ feed = 100 ppm | 5.5 | | 450 | 880 | this |
| | | | | | work |
| Meⁿ⁺ feed = 100 ppm | 6.5 | | 570 | 1320 | |

^{I}At high feed of 5 wt %
^{II}At 500 ppm feed
^{III}At 0.5 ppm feed
^{IV}For Pb²⁺ feeds higher than 500 ppm.
^{V}Not reported
^{VI}Performed in acetonitrile
N/A = not available

[42] M. Nováček et al., J. Mater. Chem. A 2017, 5, 2739.
[43] G. Zhao et al., Environ. Sci. Technol. 2011, 45, 10454.
[44] H.-P. Cong et al., ACS Nano 2012, 6, 2693.
[45] J. Mao et al., J. Mater. Chem. A 2017, 5, 11873.
[46] Y. Chen et al., J. Mater. Chem. A 2013, 1, 1992.
[47] Y. Yu, G. Zhang, L. Ye, J. Appl. Polym. Sci. 2019, 136, 47318.
[48] F. Ge et al., J. Hazard. Mater. 2012, 211-212, 366.
[49] X. Guo et al., J. Hazard. Mater. 2014, 278, 211.
[50] M. A. Tofighy, T. Mohammadi, J. Hazard. Mater. 2011, 185, 140.
[51] Y. Li et al., RSC Adv. 2019, 9, 397.
[52] B. Wang et al., Adv. Mater. 2012, 24, 1111.
[53] Y. Peng et al., Nat. Commun. 2018, 9, 187.
[54] H. Xue et al., Chem. Sci. 2016, 7, 5983.
[55] L. Ma et al., J. Am. Chem. Soc. 2016, 138, 2858.
[56] P. Bhunia et al., Chem. Commun. 2012, 48, 9888.
[57] J. Kolařik et al., ACS Nano 2021, 15, 3349.
[58] D. T. Sun et al., ACS Cent. Sci. 2018, 4, 349.

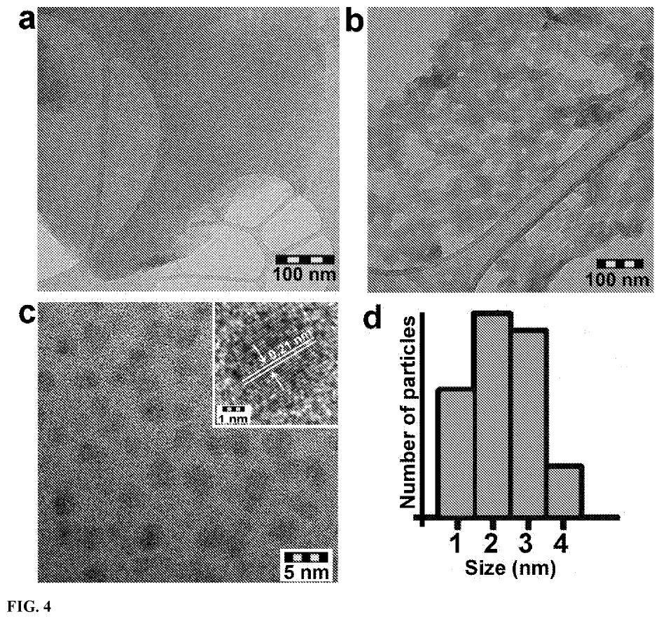

The morphology and microstructure of NG, NGA, and NGA-D were analyzed by transmission electron microscopy (TEM, FIG. 4), showing that NG comprised few-layered graphene flakes with size around 600 nm. The NGA flakes were smaller, ca. 50 nm, due to the oxidative cutting from the action of concentrated nitric acid, showing high proclivity to interact with each other. After hydrothermal treatment at 90° C., graphene dots of very small size in the range of 2-3 nm were formed (NGA-D), with a lattice spacing of 0.21 nm corresponding to that of graphene {1100} lattice fringes. After measurement of lattice spacings from more dots, only these fringes were observed, confirming the dominant presence of single or few-layered graphene dots sitting flat on the grid, rather than carbon dots, which are multilayered with interlayer spacing of ca. 3.4 nm. The abundance of single-layered graphene dots was further confirmed from the selected area diffraction from many dots, showing the {1100} diffraction peak much brighter than the {2110}. Atomic force microscopy (AFM) showed an average thickness of 3 nm, corresponding to single-layer sheets, considering that unfunctionalized single layer graphene shows AFM thickness up to 2.6 nm.

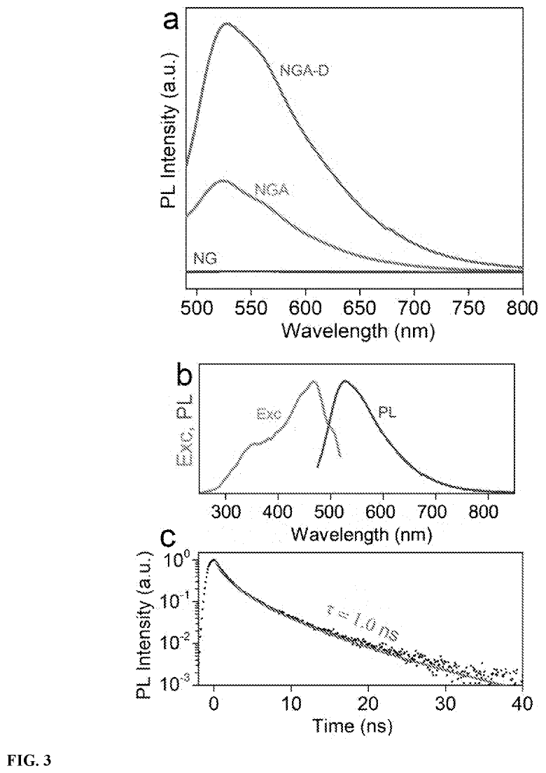

PL measurements at room temperature of NG, NGA, and NGA-D dispersed in water did not show any PL for NG, but after oxidation NGA exhibited a PL maximum at 523 nm under 470 nm excitation (FIG. 3). The appearance of PL can be ascribed to quantum confinement effects due to the development of small sp² islands isolated by the sp³ carbons bonded to the oxygen functionalities, overall forming the PL-active surface states. The thermal treatment of NGA resulted to PL enhancement in the NGA-D product, keeping the same photophysical characteristics, which could be thus attributed to the significant reduction of the lateral dimensions of the NGA sheets in the form of discrete dots, increasing further the content in quantum-confined areas. The increased PL intensity could be also ascribed to the improved quality of the dispersion in the NGA-D product in comparison to the NGA system, since interparticle interactions can cause PL quenching. The excitation-emission map of NGA-D showed excitation-independent emission, suggesting that PL originates from dots with very similar band-gap states, due to their monodispersity. Along with the small Stokes-shift of ca. 50 nm, these observations suggest the absence of interlayer interactions, which usually lead to formation of excimers and energy-transfer (responsible for the large Stokes-shift and excitation-dependent PL, respectively) in carbon dots. The absorption spectrum of NGA-D showed a perturbation between 400-500 nm, with a maximum at 460 nm, as verified by the derivative curve, coinciding well with the excitation maximum of 467±2 nm. The band-gap value of 2.8 eV (i.e., 440 nm) for the NGA-D, as calculated from Tauc plot, was also found in agreement with the spectral features. The PL emission peak of NGA-D under the excitation of 467 nm was centered at 527 nm (FWHM of 119 nm) with a PL lifetime of 1.1 ns, as obtained from fitting the PL decay by a stretched-exponential function.

1. A nitrogen doped graphene acid containing 3 to 10 at. % of nitrogen, 25 to 45 at. % of oxygen, and 0.1 at. % to 1.3 at. % of fluorine, relative to the total atoms present in the sample and determined by X-ray photoelectron spectroscopy (XPS) containing an Al—Kα source.

2. The nitrogen doped graphene acid according to claim 1, containing 4 to 6 at. % of nitrogen and 30 to 38 at. % of oxygen, relative to the total atoms present in the sample and determined by X-ray photoelectron spectroscopy (XPS) containing an Al—Kα source.

3. The nitrogen doped graphene acid according to claim 1, wherein the nitrogen doped graphene acid exhibits an infra-red band between 1690 cm-1 and 1750 cm-1, and an infra-red band between 1180 cm-1 and 1250 cm-1, wherein the bands belong among the 5 strongest bands in the infra-red spectrum, as determined by attenuated total reflectance FT-IR spectroscopy; and wherein the nitrogen doped graphene acid exhibits photoluminescence with a peak between 475 nm and 600 nm when excited at 470 nm, as determined with a fluorescence spectrometer at room temperature with a sample dispersed in deionized water.

4. The nitrogen doped graphene acid according to claim 1, wherein the nitrogen doped graphene acid is in the form of particles having the largest dimension of up to 500 nm, as determined by transmission electron microscopy.

5. The nitrogen doped graphene acid claim 1, wherein the nitrogen doped graphene acid is in the form of nitrogen doped graphene acid dots having the size of 1-5 nm, as determined by transmission electron microscopy.

6. A method for preparation of nitrogen doped graphene acid according to claim 1, comprising the following steps:
providing nitrogen doped graphene wherein the nitrogen doped graphene is produced using the following steps:
a) providing a dispersion of fluorinated graphite;
b) subjecting the dispersion of fluorinated graphite to sonication and/or mechanical treatment and/or thermal treatment;
c) contacting the product from step b) with an azide reagent at a temperature of 40 to 200° C.;
d) separating the solid nitrogen-doped graphene formed in step c) from the mixture;
e) optionally dialysis of the nitrogen-doped graphene against water;
oxidizing the nitrogen doped graphene by reaction with an oxidizing inorganic acid, and
washing the resulting mixture with water.

7. The method according to claim 6, wherein the step of oxidizing the nitrogen doped graphene by reaction with an oxidizing inorganic acid is carried out with concentrated nitric acid, at a temperature within the range of 40-200° C., wherein the heating is carried out for at least 4 hours.

8. The method according to claim 6, further comprising a subsequent step of hydrothermal treatment of the nitrogen doped graphene acid in autoclave by heating to a temperature within the range of 40-150° C.

9. The method according to claim 6, wherein the nitrogen doped graphene acid after the washing step and/or the nitrogen doped graphene acid dots after the hydrothermal treatment step are subjected to a step of dialysis against water.

10. A method of sequestration of Pb2+ and/or Cd2+ from water, comprising nitrogen doped graphene acid according to claim 1.

11. The method of sequestration of Pb2+ and/or Cd2+ from water according to claim 10, wherein water is selected from river water, drinking water, wastewater.

12. The method of sequestration of Pb2+ and/or Cd2+ from water, comprising the step of contacting water to be purified of Pb2+ and/or Cd2+ with the nitrogen doped graphene acid of claim 1.

13. The method according to claim 12, comprising the step of recycling the nitrogen doped graphene acid after the contacting step by washing it with an inorganic acid, and re-using it by contacting it with a new batch of water to be purified of Pb2+ and/or Cd2+.

14. The nitrogen doped graphene acid dots according to claim 5 for detecting Pb2+ and/or Cd2+ by photoluminescence.
